(19) United States
(12) Patent Application Publication
(10) Pub. No.: US 2005/0004824 A1
(43) Pub. Date: Jan. 6, 2005

(54) System and method for concurrent recording, using and recovering a multi-referenced data in a real-time control system for a plant product sorting system

(75) Inventors: James B. Sheffler, Chino Hills, CA (US); Steven D. Stebbins, Highland, CA (US); Alfredo J. Gomez, Anaheim, CA (US); Ephraim Suazo, Corona, CA (US)

Correspondence Address: SUGHRUE MION, PLLC, 2100 PENNSYLVANIA AVENUE, N.W., SUITE 800, WASHINGTON, DC, 20037, US

(73) Assignee: SUNKIST GROWERS INC.

(21) Appl. No.: 10/841,478

(22) Filed: May 10, 2004

Related U.S. Application Data
(60) Provisional application No. 60/469,016, filed on May 9, 2003.

(51) Int. Cl. G06F 19/00

(52) U.S. Cl. 705/7; 705/28; 700/97

(57) ABSTRACT

The present invention concerns a method of operating a plant product processing arrangement that is operative to process a plurality of plant product objects. The plant processing arrangement has an input, an output and processing, detecting, conveying and sorting equipment therebetween. The method includes initially establishing at least one operational plan, the at least one operational plan defining short term operational parameters and controlling processing facility operations, including plant product detection, conveying, sorting and takeout at said output. The method further includes establishing an enhanced or “reference” plan, the reference plan defining long term value-related parameters. Then, the method involves processing plant product objects according to at least one operational plan from plant product input through plant product takeout and detecting measurable parametric characteristics of each of the plant product objects during the processing step. The detected parametric characteristics measured for each of the plant product objects are stored, and then compared to the long term value related parameters. A comparison result for each plant product object is generated and the comparison result is stored for subsequent access, for analysis, reporting, management, payment or the like.

### BACKGROUND OF THE INVENTION

The present invention relates generally to a system and method for concurrently recording, using and recovering multi-referenced data in a real time control system for handling objects, such as fruit or vegetable products, in a grading and sorting system. In particular, the invention concerns a technique for recording data about plant products according to user definable parameters, such as size, color, grade, type, source, and the like. More particularly, the invention concerns a method and apparatus for detecting and storing data related to plant products, such as citrus fruit, which are collected from growers and delivered to packing houses for sorting, storage and/or shipping, where data related to all plant products processed by the packing house is collected and stored for further reporting, analysis and business-based management, such as payment to growers or the like.

In the plant product processing industry, plant products are collected in the field in field boxes or bins, or other appropriate containers, and shipped to packing houses or other processing centers where they are preliminarily sorted to remove trash (twigs, leaves, etc), damaged plant products, undersized or otherwise undesirable products. Thereafter, the plant products are appropriately treated, separated or processed for subsequent shipping, storage, juicing, freezing or the like.

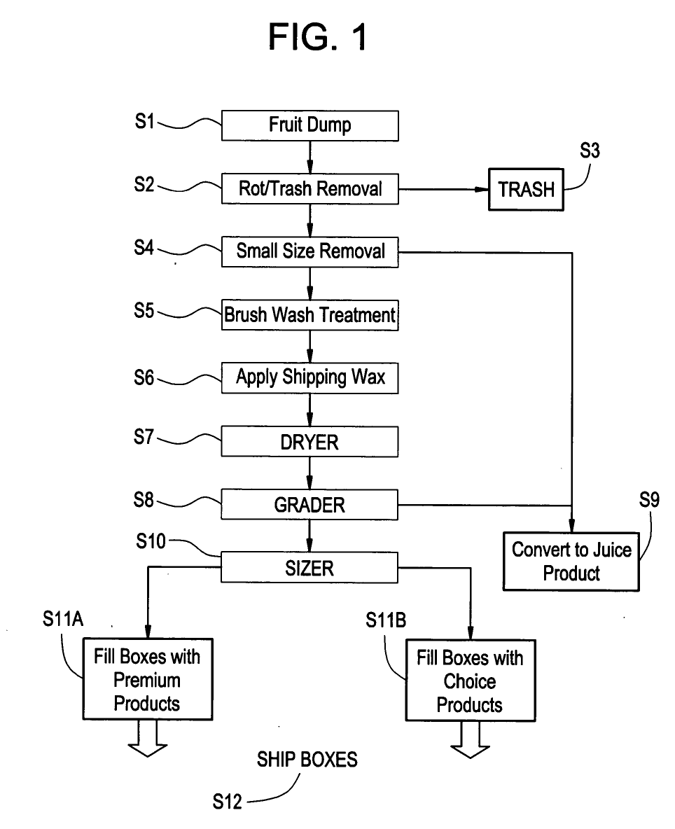

An example of the flow of such process in a packing house may be seen in FIG. 1, however it should be recognized the illustrated process is merely exemplary and may be applicable to many types of plant products with appropriate modification, as would be understood by those skilled in the art. The illustrated process of FIG. 1 is generally applicable to citrus fruit, and is particularly applicable to lemons.

At the beginning of the process at a packing house, lemons that have been collected in boxes or bins, are dumped into a main packing line in step S1. Immediately, the lemons that are rotted, damaged or otherwise wholly unacceptable and are considered trash, are removed in step S2, typically by human inspectors, and discarded in step S3. Such damaged lemons would be unacceptable due to lack of consumer demand or susceptibility to contamination of other lemons. Subsequently, lemons that are undersized are removed in step S4 and processed into products such as juice in step S9. The remaining lemons that appear suitable for packing are brush washed in step S5 and coated with a shipping wax, in order to prevent damage and lost of moisture, in step S6 and are then dried in step S7. The lemons are now ready for packing and in step S8, the remaining lemons are graded. In an exemplary grading system, citrus products may be separated into three categories, premium, choice and juice. Products which fall below the premium standard or the choice standard are converted to juice in step S9. Products that qualify for a premium grade or choice grade are sized in step S10 and are separated in line S11A into a first group that, optionally, is trademarked and filled in premium grade boxes. The choice grade products are directed in the sizing step S10 to path S11B and filled in choice grade boxes. Both the premium and choice boxed products are shipped in step S12 for distribution to secondary packers or consumers.

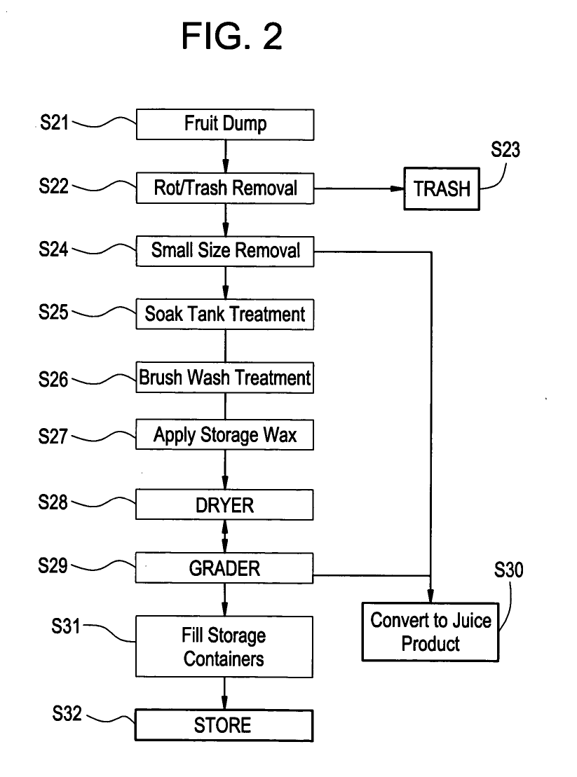

Certain plant products are adapted for long term storage, both because they resist rapid decay and/or are improved in quality and consumer preference during the storage operation. An exemplary flow chart for such storage operation, particularly a lemon storage operation, is illustrated in FIG. 2. As would be known to those skilled in the art, the illustrated process is subject to modification, depending on the plant product involved. In the exemplary embodiment of FIG. 2, lemons in boxes or bins are received in the packing house and are dumped onto the processing line at step S21, followed by the removal of rotted plant products or trash in step S22, typically by human inspectors, and the disposal of that trash in step S23. Inspection steps may be conducted at various points throughout the entire plant product processing, as would be understood by one skilled in the art. Lemons having a small size are removed in a subsequent step S24 and sent to a juice processing step S30 Normal and oversized fruit may be soaked in water or applicable solution, or otherwise treated in step S25 to remove bacteria, dirt or other disease bearing agents. The lemons are then brush-washed in step S26 and coated with a storage wax in step S27. After drying in step S28, the lemons are then graded in step S29, for example, according to the multi-grade system utilized for shipped fruit, or other appropriate grading system that is based on defects, color, shape or other appropriate parameters. In the exemplary embodiment of FIG. 2, lemons that are less than prime or choice are diverted to a juice processing step S30, although market conditions or storage limitations may dictate that choice products or even all products should be converted to juice as well. The fruit that is of premium or choice grade is placed into containers in step S31 and stored in step S32 for an appropriate period of time. The placement into containers may be accomplished without separating the choice and premium grades, as illustrated in FIG. 2 since such grades may change on the basis of market conditions. However, as would be understood by one skilled in the art, such separation prior to storage could be implemented, as in the process of FIG. 1. In any event, after storage, and on the basis of demand the plant product would be removed from storage, sorted and distributed.

In certain plant product industries, the grower is paid on the basis of the quantity and quality or grade of the plant products that are provided to the packing house. However, plant product production is both regional and seasonal. Many growers will plant several varieties of plant products so that harvesting can be conducted over a longer period of time, as the plant products mature at different times of the year. Also, growers often are members of co-op systems through which harvesting equipment is shared, thus requiring concurrently maturing plant products at different locations to be harvested at slightly different times. Thus, typically, multiple growers will be providing their plant product output to a local packing house at the same time, thereby requiring the processing of a large volume of different plant product in the packing house facilities. This process requires consistent standards and accurate record keeping so that each grower may be fairly compensated for the products that have been delivered.

The packing house generally will collect data in accordance with a scheme or “operational plan”, by which plant products are classified according to a set of user-definable parameters, such as size, color, grade, etc. The plant products are processed along one of several packing house “lines,” comprising conveyors, elevators, washers, waxers and inspection sites, etc., and distributed to “take outs” where the product is sent to storage or shipping bins, according to the packing house definable information in the operational plan. The inspection sites have either electronic, mechanical or human inspection capability. The electronic capability includes optical scanners for detecting color and textural characteristics of the plant products, or other electronic detectors for weight, density, chemical content or the like. Mechanical detectors may include size or shape discriminators, while the human inspectors rely upon experience and skill to provide a highly subjective identification of product characteristics. Data related to each of these different inspections is generated and accumulated in a variety of ways, as is known in the art. The packing house generally wishes to group the collected data relating to the plant products in sets, such as by quantity for a specific grower, and will define the groups of data as a “lot.” In the citrus industry, a “lot” is typically comprised of a predetermined number of bins and each bin may contain, for example, 4,000 lemons or 3500 oranges. For lemons, there are 16 boxes per bin and 1 and ½ cartons per box. Each lot is assigned an ID indicator and has a start and stop time stamp that defines the period within which the plant products are processed in the packing house lines. ID indicator and time stamp may be assigned to the storage or shipping containers in which the plant products are placed.

The parameters that make up the “operational plan” are user-defined on a short-term basis and are influenced by many factors, such as mechanical failures, plant product conditions, storage conditions and marketing considerations, for example. This data is significant because a grower's compensation may depend upon the lot-based data that is collected under the operational plan, including size and grade of the plant products.

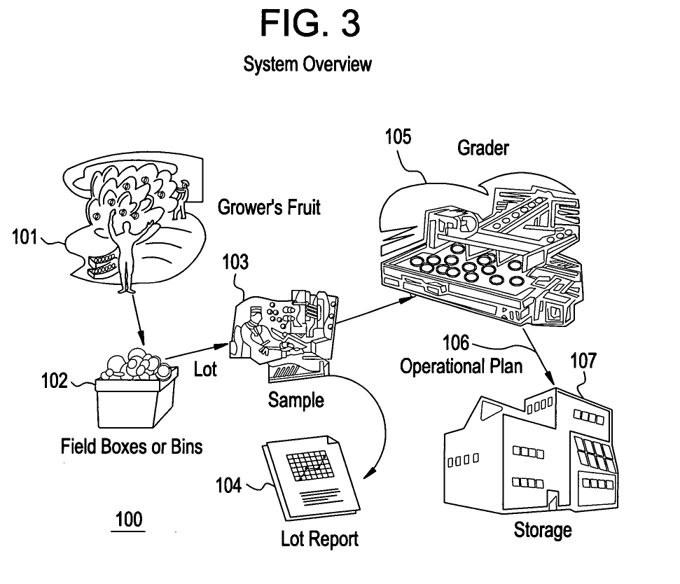

An overview of a system in which plant products are harvested and processed by a packing house in real-time, according to an operational plan, and appropriate data collected, is illustrated in FIG. 3. There, the schematic illustration of an exemplary flow of plant products, specifically fruit products such as lemons, is illustrated in the system 100. Beginning with the harvesting of a growers fruit in the field 101, field boxes or bins 102 are filled with the fruit and delivered to the packing house where the processes of FIGS. 1 or 2 may be followed.

Following rot and trash removal according to those processes, the lemons in lot quantity are subject to a manual inspection 103. In the citrus industry, the inspection is performed of a small percentage, typically under 1%, of the overall quantity of fruit being processed by the packing house, and a statistical sample is collected by subjective review of the fruit by a skilled operator. Nonetheless, there is limited functionality in this subjective process as relatively small number of grades and sizes may be accommodated. For example, for lemons, sizes may include designations such as 75, 95, 115, 140, 165, 200 and 235, as well as oversize (greater than 235) and letts (under 75).

One such statistical grading system is a SampleTron™, which is based upon an arm-like device that randomly selects samples for diversion from a main flow into a grading station where a human grader will identify the products as prime, choice or juice. At this point, the pieces are classified by the operator according to shape, scarring and texture. Typically the size of the plant product is determined by optical sensors on an automatic basis by a machine. Growers are paid on the basis of the grading, rather than size.

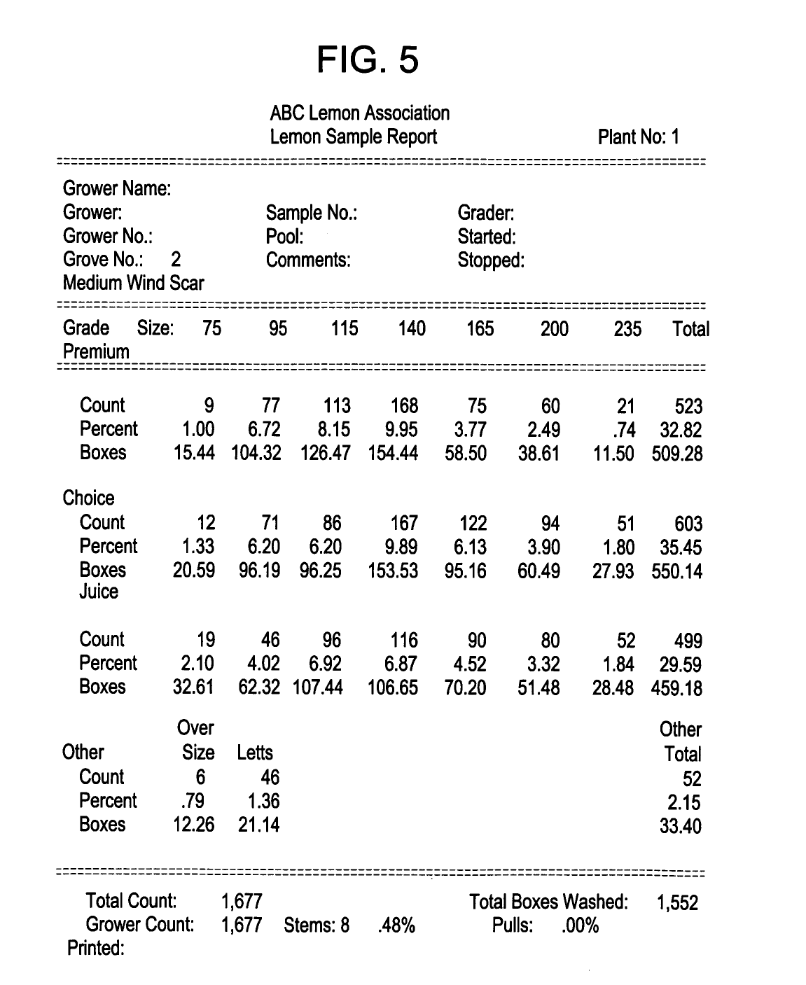

In this exemplary embodiment, the grading of the fruit would include three categories, such as premium, choice and juice, though more or fewer could be used. The statistically sampled and subjectively evaluated product result is provided in a report, conventionally known as a “lot report” 104. An example of such report is illustrated in FIG. 5 for a particular packing house (ABC Lemon Association), particular plant (No. 1) and particular grower (ABC Grower). Data involving the particular lot being sampled, the graders name, the grove, the pool of fruit, the condition of the fruit in general (e.g., medium wind scar) and the start and stop times, as well as a breakdown of the samples by size and grade, is provided. The report identifies the grader's evaluation, based on sampling, of the number of premium, choice, juice or other grades (including oversize, letts and trash, e.g., “pulls” or “stems”) of lemons for different sizes, in a given pool of lemons that has been sampled.

While only a small fraction of the plant products, e.g., lemons, is actually sampled for statistical purposes, the entire batch of fruit is forwarded to a grader 105 which separates the fruit according to a selected one of several operational plans 106 for further processing (e.g., sizing) and packing into boxes for storage 107.

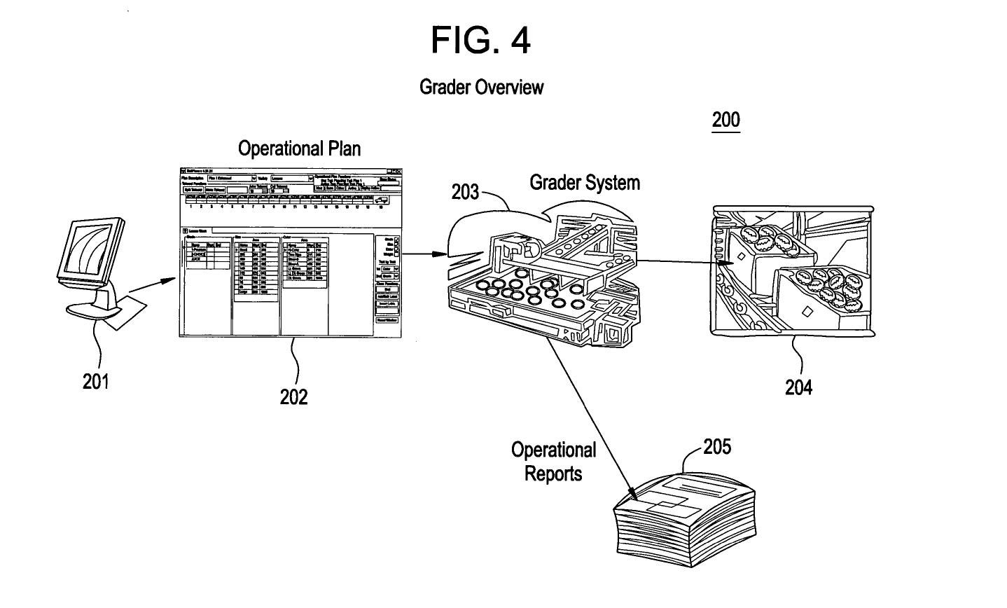

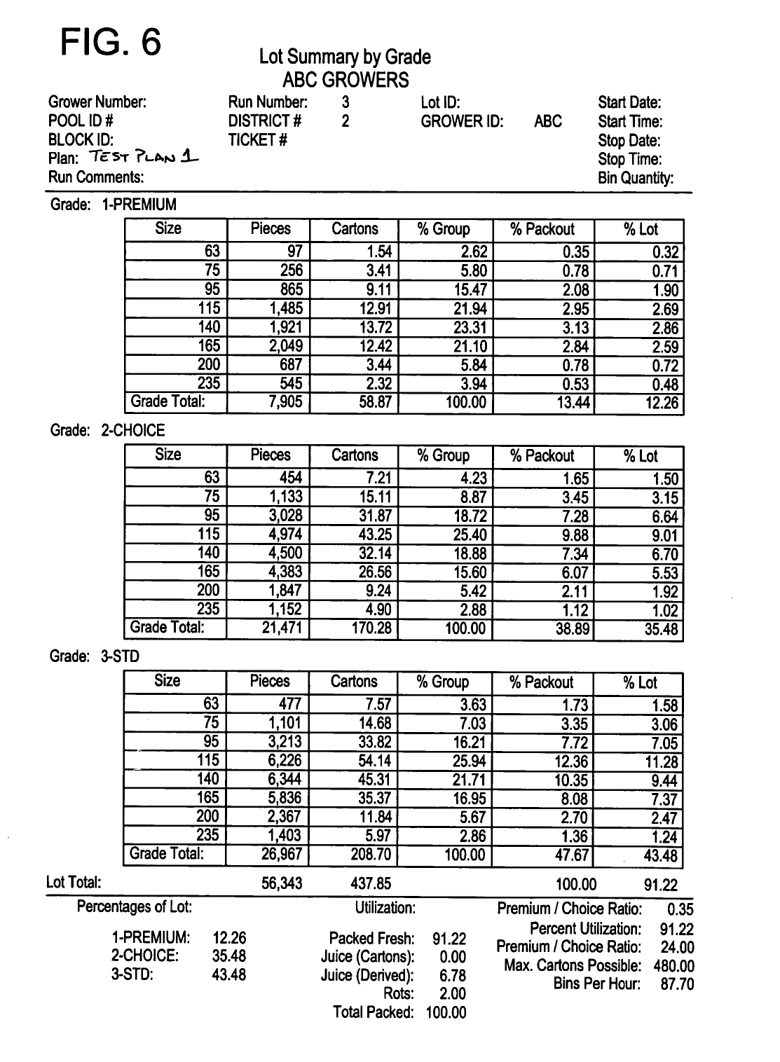

In the automated grading process 200, as illustrated in FIG. 4, a computer 201 is in control of the selected operational plan 202 and determines the standards by which the grader system 203 will perform. In a conventional system, the fruit is distributed to different “lanes” and is optically inspected and sized, in accordance with their evaluation. A “group” or “user-defined set of lanes” is established (e.g., group 1 comprises 3 lanes for purple fruit and group 2 comprises 5 lanes for red fruit) and the “takeout” for the pieces coming from different lanes and after inspection is also identified. At periodic intervals, the number of pieces of fruit objects in each class, the lane each piece was presented on, the group the lane belongs to, and the take-out the piece was distributed to is collected and stored in a database along with a lot ID indicator. The start and stop time stamp for each lot is also collected. This information is presented in operational reports 205, which represent the evaluation of each lot against the then currently defined parameters of an operational plan. A typical machine grade lot summary for the ABC Lemon Association, reporting on the results of the processing of fruit product from the ABC Grower is illustrated in FIG. 6. This report identifies the particular operational plan (here a test plan No. 1) by which the lot of fruit has been evaluated. Data concerning the time and quantity of product processed is also reported. The report specifies for each of the relevant grades (premium, choice, and juice), for each of the relevant sizes, the number of pieces that have been processed as well as comparable information by “cartons” (representing 1/24^{th} of a bin or ¾ of a storage box), as well as the percentage of the group represented by each size and grade, percentage packout and percentage of a lot.

In the report illustrated in FIG. 6, a summary for the ABC Lemon Association, reporting on the results of the processing of product from the ABC Grower according to a specified operational plan (test plan 1) is stated according to the utilization intended for the product. For example, premium and choice product is packed fresh while juice products are converted to juice in different forms. A report on the number of rotted fruit products is also provided so that a total representation of the fruit product that has been packed is presented for quality control, processing, analysis and payment.

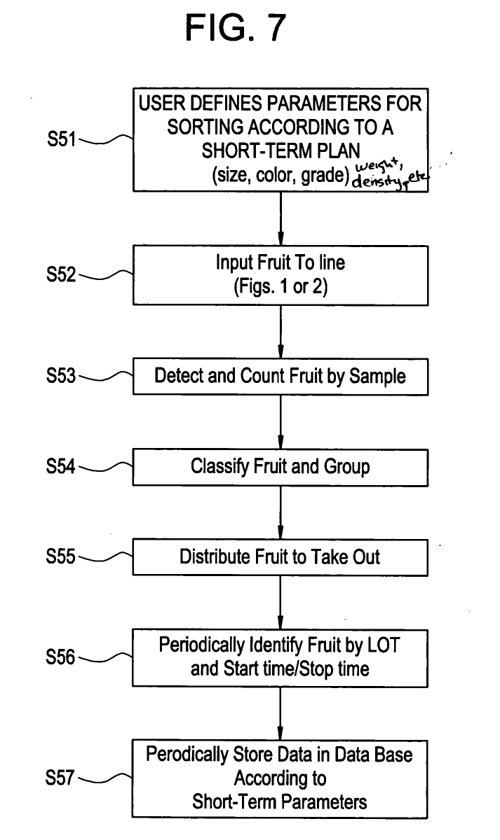

One or more pre-defined “operational plans,” with critical parameters and control instructions in software form, may be available to the packing house. Typically, the parameters of the operational plan are specified on a short-term basis, or one of a variety of plans is selected, reflective of current market conditions, packing house operational conditions or the like. In defining the features of an operational plan, as illustrated in FIG. 7 for an exemplary lemon product process, the packing house specifies the applicable parameters for the short-term operational plan in step S51, including size, color and grade of the lemons being processed. These parameters are defined from time to time as conditions change, both in the market as well as in the condition of the fruit and storage arrangements. These parameters may be redefined over a period of hours, days, weeks, months or fractions thereof, depending upon the variable conditions. Thus, for any given producer, identical lots of fruit may be evaluated in a different manner, depending upon the operational plan in existence at any time during the season. Alternatively, one of a group of pre-defined plans may be selected for processing at any given time, reflective of market or packing house conditions.

In a second step S52, the lemons are input to the packing house system for processing according to the flow charts, is detected and counted (S53). Thereafter, the lemons are classified in step S54 and is distributed in step S55 to a takeout. This processing by lot is conducted on a periodic basis under processor control, and each group of fruit processed is identified by a lot ID as well as a start time stamp and stop time stamp (S56). Periodically, the data collected is stored in a database within the processing system, according to step S57.

As noted, a problem with the use of the operational plan for data collection is that there is an inconsistency in the applied parameters over the course of an entire growing season, or other relevant period of time. Because of the differences in market conditions that determine the manner in which a product is graded and sorted, the statistical data for the product of any given grower of the course of a season will vary depending upon the operational plan then in existence. However, the data that is collected, since it is variable over the course of a season on the basis of changes in the operational plan, as well as the purely statistical nature of the sampling that occurs using the SampleTron™ equipment and technique, cannot ensure a desired consistency in the data collection and reporting process. Because of the changes that occur in the operational plans over the course of the season, the data for an entire season cannot be meaningfully assembled, processed and utilized for performance evaluation, payment or prediction of future needs.

The inventors have recognized the need for an improved system for concurrent recording, using and recovering of multi-referenced data in a real time control system for a fruit object sorting system, particularly a packing house system.

### SUMMARY OF THE INVENTION

The present invention concerns a method of operating a plant product processing arrangement that is operative to process a plurality of plant product objects. The plant processing arrangement has an input, an output and processing, detecting, conveying and sorting equipment therebetween. The method includes initially establishing at least one operational plan, the at least one operational plan defining short term operational parameters and controlling processing facility operations, including plant product detection, conveying, sorting and take out at said output. The method further includes establishing a reference plan, the reference plan defining long term value-related parameters. Then, the method involves processing plant product objects according to at least one operational plan from plant product input through plant product take out and detecting measurable parametric characteristics of each of the plant product objects during the processing step. The detected parametric characteristics measured for each of the plant product objects are stored, and then compared to the long term value related parameters. A comparison result for each plant product object is generated and the comparison result is stored for subsequent access, for analysis, reporting, management, payment or the like.

The invention also concerns a method of grading plant products provided in bulk to a plant product processing facility having processing equipment for at least one of grading and sorting plant products and operative to execute predefined plant product processing. The method comprises establishing long-term value-related parameters, measuring parametric characteristics of individual plant product objects, comparing the long-term value-related parameters to the measured parametric characteristics, and classifying each of the plant product objects on the basis of the comparing step, together with generating classification data from the classifying step. Thereafter, the classification data for each of the plant product objects is stored for subsequent analysis, management, reporting and the like.

The invention further concerns a method of paying growers for plant products supplied for processing to a packing house. The method comprises first establishing at least one set of long-term value-related parameters and then performing machine-based measurement of parametric characteristics of all individual plant product objects. The at least one set of long-term value-related parameters are then compared to the machine-based measured parametric characteristics and each plant product object is classified on the basis of the comparing step. Classification data from the classifying step is generated and stored, and thereafter, the classification data is utilized for payment to growers of the plant products provided to the packing house.

The invention also concerns plant product processing assembly comprising a plant product input for receiving in bulk a plurality of plant product objects, a plant product output for taking out plant product objects in containers, a plant product conveying system for conveying plant product objects past a plurality of processing and detecting locations, the processing locations comprising at least grading and sorting equipment and the detecting locations comprising at least one of optical and electronic sensors for generating plant product data. The assembly further has a computer processing system for controlling operation of the plant product processing assembly, the computer processing system comprising at least one CPU and at least one memory, the memory being operative to store the plant product data and a plurality of operational programs. There also is at least one long term analytical or “reference” program, utilizing parameters for grading and classifying all of the plant product objects, the program being operative under control of the computer processing system to store classification data in the memory.

### BRIEF DESCRIPTION OF THE FIGS.

FIG. 1 illustrates a flow chart representing an example of a conventional fruit packing operation flow diagram.

FIG. 2 illustrates a flow chart representing an example of a conventional fruit storage operation flow diagram.

FIG. 3 illustrates a schematic representation of the conventional processing of grower's fruit from picking through storage in accordance with an operational plan.

FIG. 4 illustrates the overview of a conventional computer-based grader system which processes fruit in accordance with an operational plan and produces reports in accordance with such plan.

FIG. 5 illustrates the typical result of a conventional sample-based analysis of lemon products run through a packing house over a limited period of time.

FIG. 6 illustrates a machine grade lot summary that is produced for a limited run of lemon products over a period of time in accordance with a specified operational plan.

FIG. 7 illustrates a flow chart representing the definition and execution of an operational plan as performed in accordance with the conventional art.

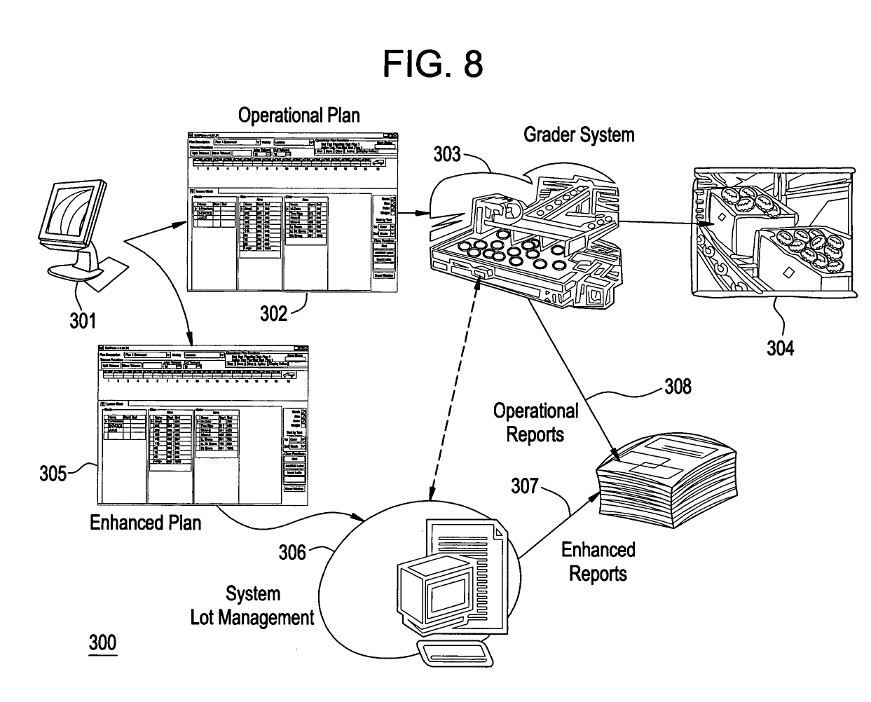

FIG. 8 provides a schematic illustration of the parallel evaluation of a fruit product run in accordance with an operational plan and a long-term or reference plan in accordance with the present invention.

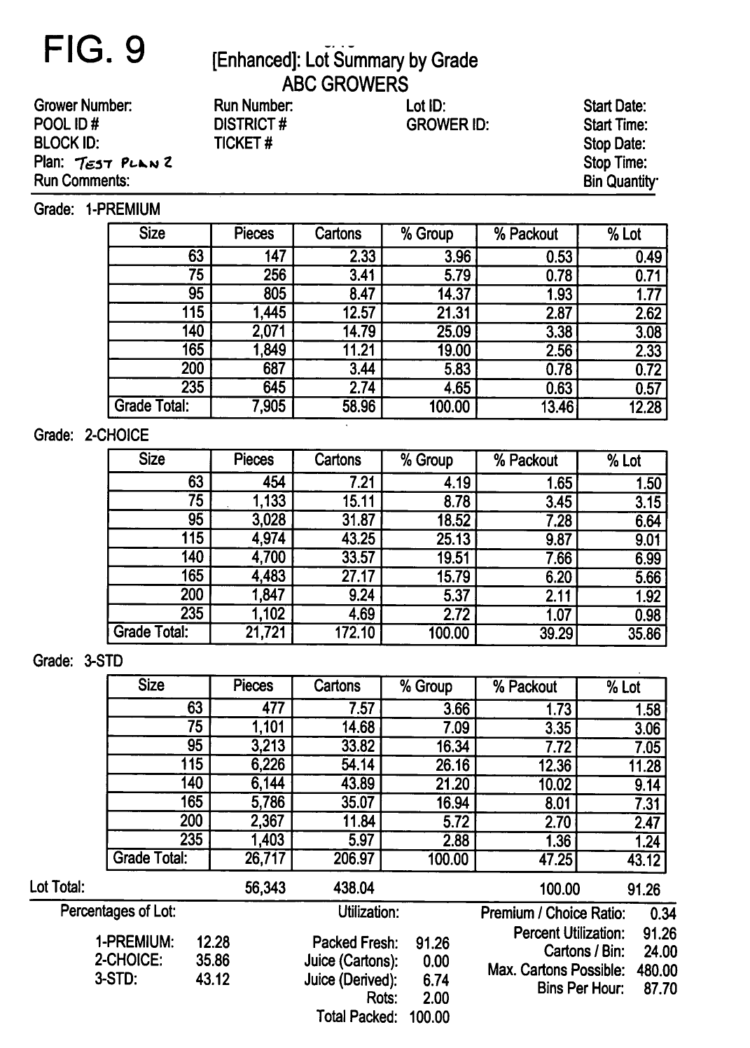

FIG. 9 illustrates a machine grade lot summary report generated in accordance with a reference plan in accordance with the present invention.

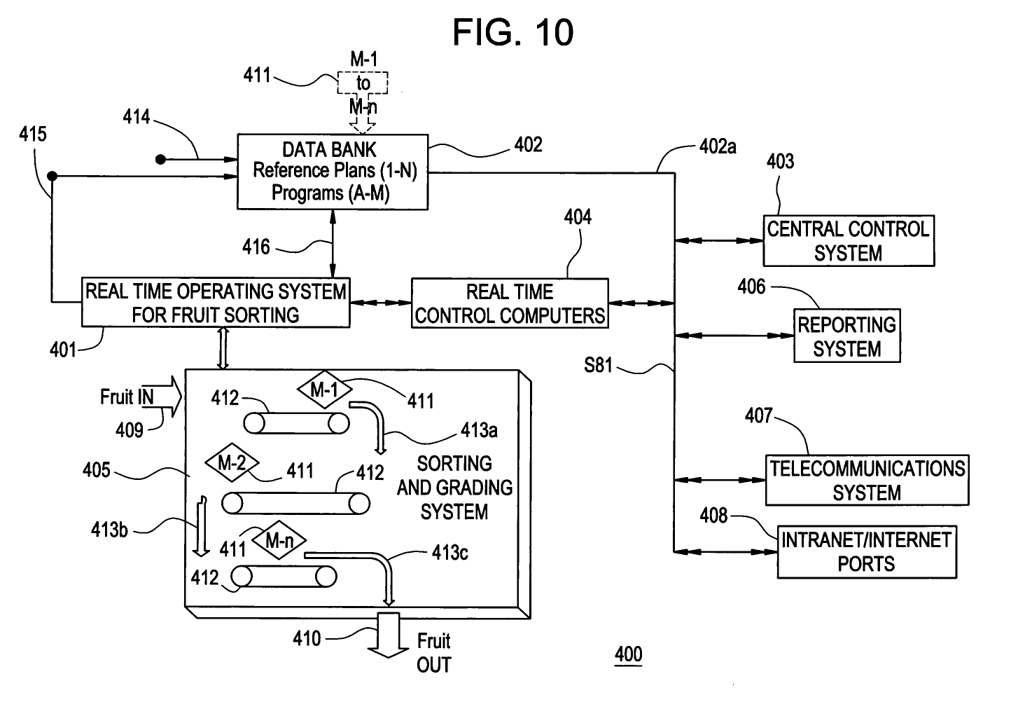

FIG. 10 illustrates a system configuration for a processor-based control of a grading and fruit sorting operation, including data bank for storage and components for reporting the result of data accumulation, processing and analysis, in accordance with the present invention.

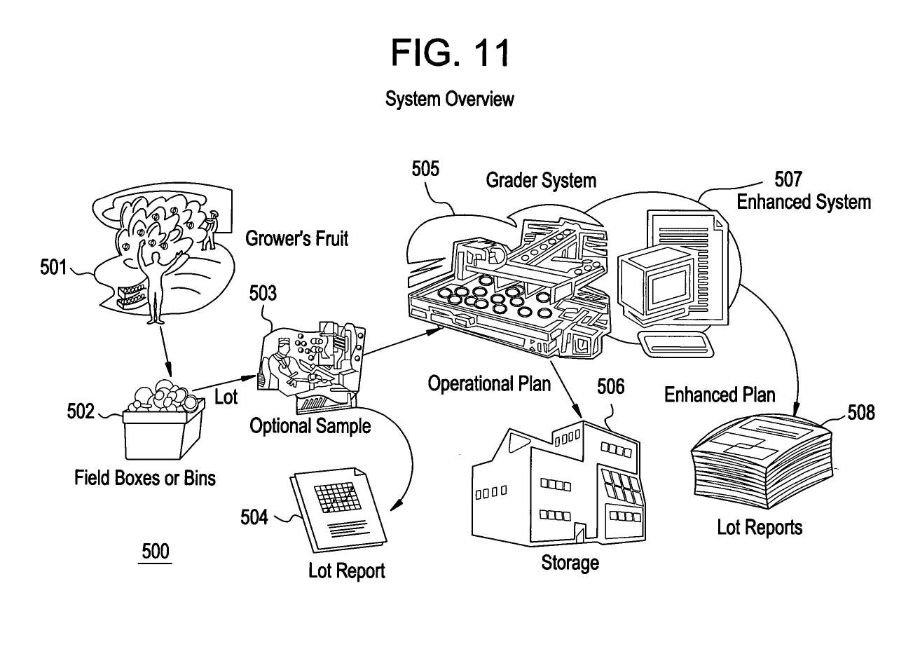

FIG. 11 provides a schematic illustration of an alternative embodiment of a system overview of the present invention, which produces only lot reports in accordance with a reference (i.e., “enhanced”) plan in accordance with the present invention.

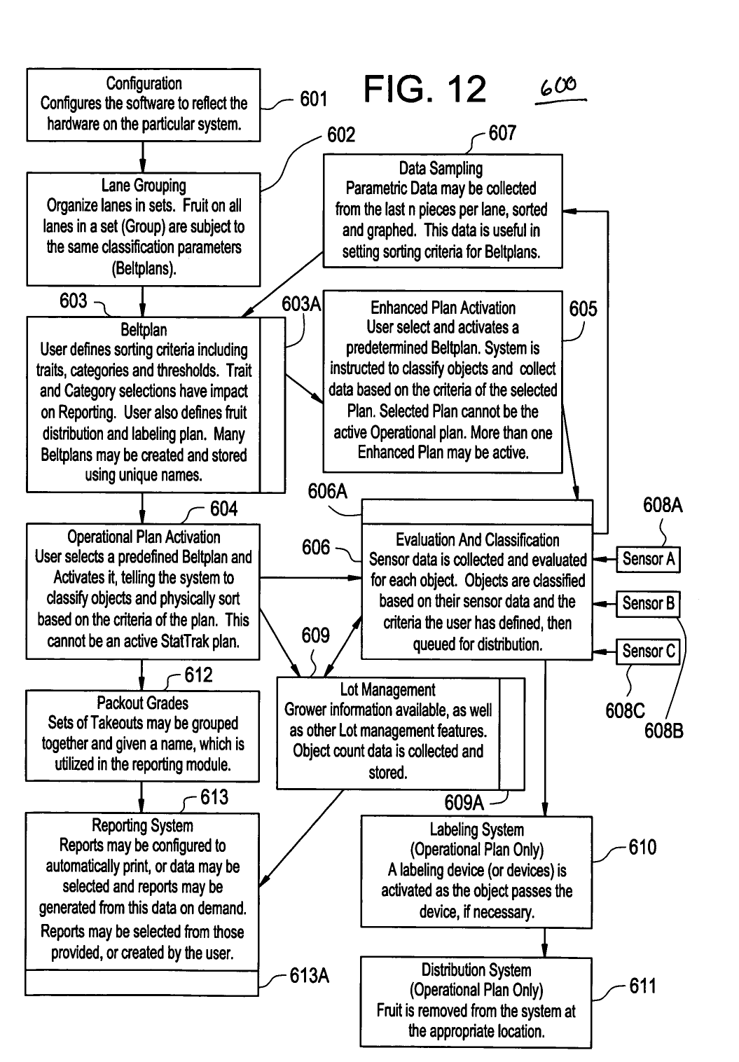

FIG. 12 illustrates a software system diagram illustrating the relationship between software controls within the operational system of FIG. 12 for both an operational plan and a reference (i.e., “enhanced”) plan in accordance with the present invention.

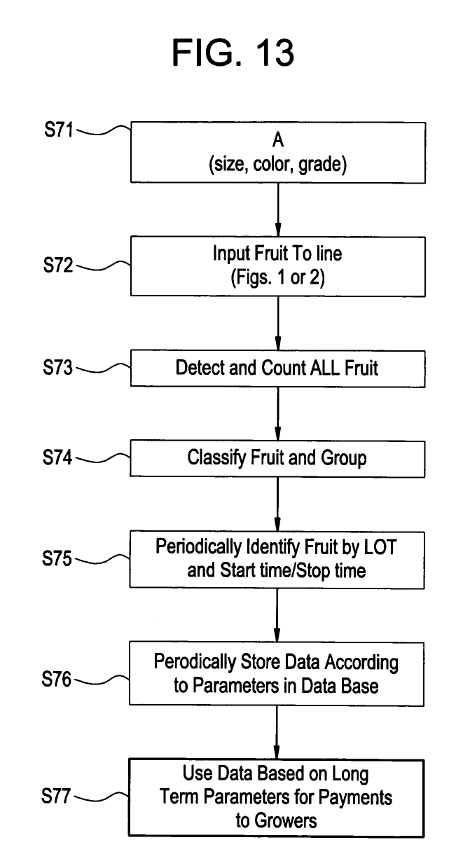

FIG. 13 illustrates a flow chart for a user to define standards for a reference (i.e., “enhanced”) plan in accordance with the present invention.

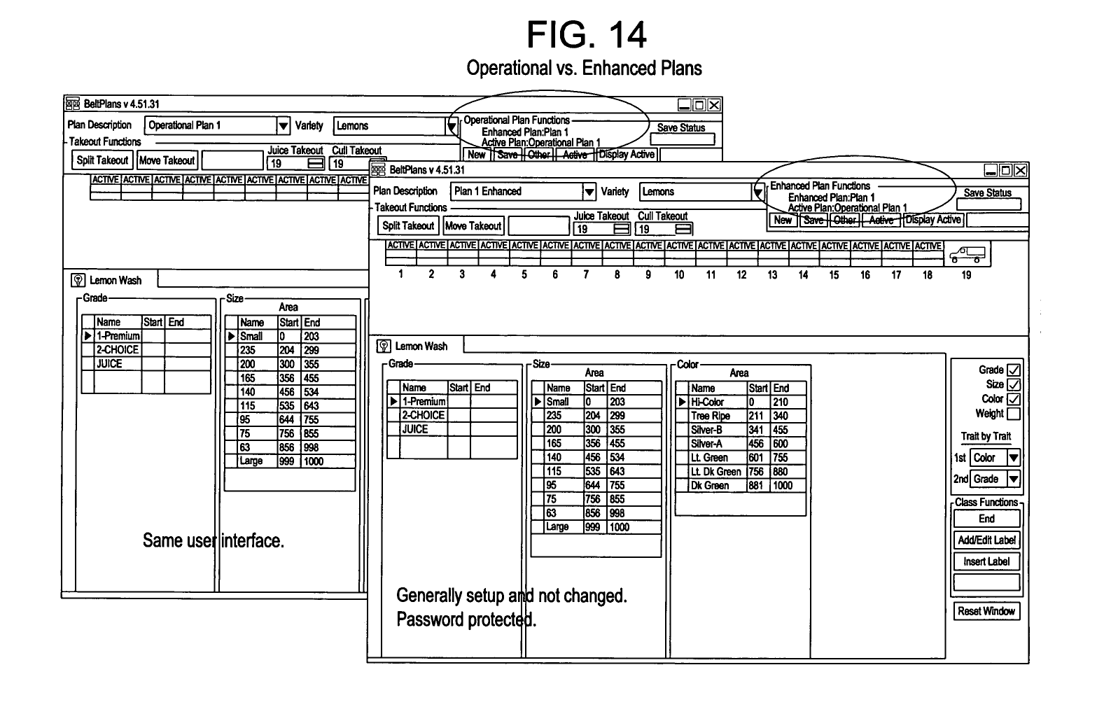

FIG. 14 illustrates a common user interface for both operational and reference (i.e., “enhanced”) plans in accordance with the present invention.

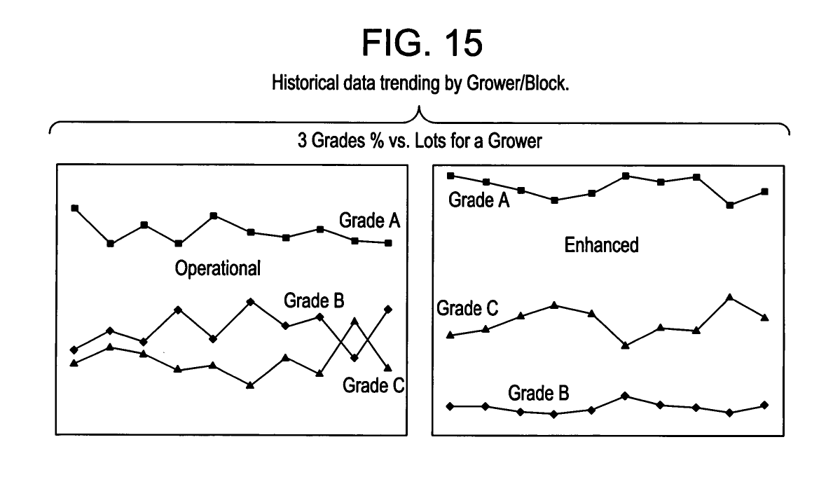

FIG. 15 illustrates differences in data between an operational plan and a reference plan. In accordance with the present invention.

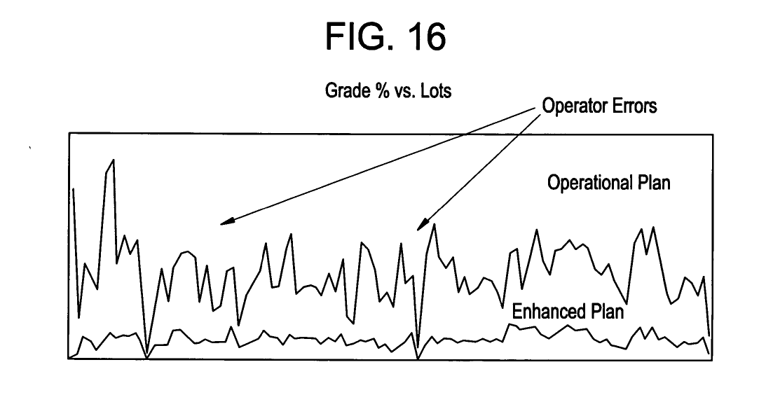

FIG. 16 illustrates a comparison between the operational plan and reference (i.e., “enhanced”) plan, in accordance with the present invention, for grade percentage versus lots.

### DESCRIPTION OF THE PREFERRED EMBODIMENT

While the present invention may be disclosed in accordance with specific embodiments, for example, lemon product based implementations, it is not limited thereto. Numerous modifications, including additions and substitutions, would be understood by those skilled in the art, and all such modifications are considered to be within the scope of the present invention, as defined by the claims appended hereto.

Recognizing the need for a data collection scheme for plant product objects that are classified according to a set of user definable parameters having greater flexibility than provided under the conventional operational plan system, a static enhanced system has been created and implemented. In accordance with the enhanced system, all of the plant products are actually evaluated, rather than in accordance with a statistical sample. Further, consistent and objective electronic grading is provided for the analysis of all the products. Thus, greater functionality can be achieved by having a wider variety of user-defined grades, sizes and color categories.

In accordance with the improved system disclosed herein, a packing house is able to set up and maintain a standard against which plant products for an entire season, or other defined period, are compared and/or classified, and the data related thereto stored for ready retrieval and analysis.

In accordance with the first embodiment of the invention, as schematically illustrated in FIG. 8, a conventional operational plan, which is implemented in order to ensure distribution of the plant products in response to a first definable set of parameters, is operated in parallel with the static reference plan, which provides an objective evaluation and reporting system, to define an integrated processing system 300. Both the conventional operational plan and the static reference plan are selected and implemented for operation in a computer-based system 301, which controls the operational plan 302 in a conventional manner. The computer processor also is operative to implement the static reference plan 305 in parallel, operating as a centralized network system; however it would be understood by one skilled in the art that a distributed computer system can also provide the appropriate controls for individual plans separately. As already disclosed, the operational plan will provide real-time control of a grader and classification system for evaluation of the plant product in a given lot or batch and distribution to takeouts for packing at station 304 for storage or further processing, as in the flow charts of FIGS. 1 and 2. Notably, the reference plan 305 will not control the operation of the grading and take out system functions in the present embodiment, those functions being reserved to the conventional operational plan. However, as explained subsequently with regard to an alternative embodiment, an integrated reference plan may control all activities in the packing house.

In accordance with the illustrated system implementation of the reference plan 305, a separate system lot management process 306 may be conducted, which receives inputs from the grader system 303 and produces an enhanced system report 307. Concurrently, the conventional operational plan may produce conventional operational reports 308, of the type illustrated in FIG. 6. However, the reference plan can produce separate enhanced reports, as illustrated in FIG. 9. As illustrated in FIG. 14, the output reports for the operational and reference plans may have a similar format, interface and setup, but report different data on the basis of differing evaluation parameters. Alternatively, modifications to the reference plan report interface may be made according to user requirements, as would be understood by one skilled in the art.

The parallel execution of the operational plan and reference plan will gather fruit object count information at the same periodic intervals in accordance with an exemplary embodiment, but such count generating periods may differ, as would be understood by one skilled in the art. The information includes the number of pieces of a plant product in each class; however, should be recognized that a given piece may fall into different classes in each respective plan. The data also includes the lane each piece was on, which would be the same for both the reference (or “enhanced”) and operational plans, the group the lane belongs to and the takeout to which a piece was directed. Such information is stored for both the reference plan and the operational plan count data. Moreover, the same lot information, including lot ID start and stop times, as well as grower information, are provided for reports generated under both plans.

In accordance with the enhanced system lot management process, a user can run fruit objects, such as lemons, from any grower at any time of the season, sort the fruit objects based on current production needs and still maintain a single standard against which all fruit objects are compared. In this regard, as illustrated in FIG. 9, a machine grade lot summary for the ABC Lemon Association, reporting on the evaluation of product from the ABC Grower and evaluated according to test plan 2 may be provided. Notably, similar reporting to that found in FIG. 6 is provided by grade and size. However, this report reflects a standardized and objective evaluation based on a standard of comparison to which all of the fruit processed by the packing house over an entire season or extended period of time is subjected. Again, this report reflects wholly different set of parameters and duration of evaluation. Significantly, because a single standard is used against which processed plant products are compared, regardless of the time of the season, a user may choose to pay growers based on this uniform-standard information. Thus, each grower is paid against the same standard of performance, regardless of when a plant product is run through a packing house. Each grower is also paid based on his entire set or lot of fruit objects over the course of an entire season.

The standardized data recording under the reference plan is placed in a bank, preferably an SQL database that is integrated into a real-time operating system, and has multiple deposit, multiple withdrawal concurrency capability. Objects are classified according to the unique set of user defined parameters and data is recorded separate from the operational plan. In an alternative embodiment, as subsequently explained, the data may be used as part of an operational plan. With a system that implements a reference plan in accordance with the present invention, data can be saved, used, archived, recovered and used to provide a basis for extended statistical analysis about the product, the process, equipment performance and system efficiencies.

With reference to FIG. 10, the overall system architecture 400 that supports an implementation of the combined operational plan and reference plan embodiment of FIG. 8, is illustrated. Notably, this same architecture is applicable to the alternative embodiments that are disclosed subsequently. The real-time operating system for controlling plant product sorting and distribution 401 is coupled to the data bank 402, which is coupled by bus 402a to a central control system 403. The data bank 402 stores the data collected for the plant products processed through the system, and is capable of correlating for each plant product object, one or more parameters that are detected by monitors M-1 to M-n as subsequently disclosed. The data bank 402 also serves to store one or more operational and reference (or “enhanced”) plans, as well as computer programs that support the operation of the system. The data bank clients also include a set of real-time control computers 404 that are coupled to the packing house sorting and grading system 405, a reporting system 406 that generates reports (of the type illustrated in FIGS. 6 and 9) in printed or other forms, a telecommunications network 407 that permits remote broadcast of production information, and intranet/internet ports 408. The system 405, as illustrated schematically to show only a representative number of components for discussion purposes, receives the plant products at an input 409 and will monitor the plant products through a set of monitors 411 disposed at a variety of locations throughout the system.

The monitors 411 may include optical, electronic, mechanical, chemical and other conventional sensors. The plant products are conveyed on conveying systems 412 and are passed through a variety of stations, represented by arrow-headed paths 413 generically, and ultimately passed to an output or takeout 410. Characteristic information on each piece of plant product passing through the system can be simultaneously collected at the variety of monitors and referenced to predetermined standard criteria when stored in the data bank 402.

The information can then be reported for various accounting processes, examined for historical and statistical trends, and communicated via electronic means for other real-time use, archived and recalled. Collected data may also be used as part of a feedback control loop for system operation, as illustrated by the feedback connections from the data bank via bus 416 and the control line 415 from the operating system to the data bank. The data functions may be operated automatically, as by the control line 415 or manually by line 414.

A schedule can be set for automatic protection or back-up of selected information in accordance with known procedures. Further, the data bank 402 can be searched to find information for restoration or reporting purposes according to techniques known in the art.

The data bank may contain a plurality of plans, both operational and reference plans as well as a plurality of programs that are referenced by the plans for monitoring and control purposes. Thus, while a given reference (or “enhanced”) plan is intended for long term application, for example, over the course of an entire season, the features of each plan for each year may be saved in memory for future selection or modification, as appropriate, at the beginning of a new season or packing period.

In a representative overall system of the type illustrated in FIG. 10 and operated by a system as illustrated in FIG. 11, a plurality of computers are used (typically 4) and are joined in a network through a server. Citrus fruit is typically processed at 10-12 pieces per second and for a plurality of lanes, for example, 16 in a typical plant environment, 160-200 pieces per second may be processed. During inspection, there are multiple pictures for each piece of fruit using multiple parameters. Each piece of fruit is examined and assigned a value (for example but without limitation, 0 to 1,000) representing color, size, weight and grading. Typically, there is one set of parameters established for a belt plan which involves a classification of the fruit for distribution or disposal.

FIG. 11 illustrates an alternative embodiment of an enhanced system in which statistical sampling and enhanced system sampling are conducted concurrently with lot reports generated from each measurement, but without the generation of reports from the operational plan. In the system 500, growers fruit 501 is collected in field boxes or bins 502 and shipped for processing to a packing house where the fruit is processed by lot according to the flowcharts of FIGS. 1 or 2, including grading in a grader system 505 and processed according to an operational plan for packing or storage 506. Using the enhanced system 507, as implemented on a system as illustrated in FIG. 11, data will be collected on each and every plant product object as it is passed through the grading system 505 and measured according to the parameters specified in the existing reference plan. The data collected according to parameters of the plan, which are user selected for long term evaluation, is stored in the enhanced system database (e.g., data bank 402 of FIG. 10) in a form for easy analysis and retrieval. Lot reports 508 are generated according to the reference plan. Optionally, as required, the conventional statistical sampling may be conducted at 503 and used to generate a corresponding lot report 504, if such conventional data gathering and reporting is desired.

Turning next to the arrangement of software that is stored in the data bank 402 of FIG. 10, and utilized by real time operating system 401 or the central control system 403 in connection with system operation and data gathering, several modules relating to the operational plan and the reference plan are provided.

Within the software assembly 600, as illustrated in FIG. 12, in module 601, configuration software exists for configuring the existing software within the data bank to reflect the hardware on the particular system, by entering information identifying its characteristics, interconnections with other software or hardware, and the like, in a conventional manner. In a subsequently implemented module 602, software exists to organize the lanes that carry the plant products, for example fruit, into “groups” as previously described. The plant products on all the lanes in a “group” are subject to the same classification parameters, such as color, size, grade, in accordance with an established “beltplan”. In module 603, software exists to define a beltplan, which reflects a user defined sorting criteria including traits, categories and thresholds. The beltplan may be preexisting or may be customized at the time. Grade and category selections will have an impact on the reports generated in accordance with an operational plan or the reference plan. In this step, the user also may define the plant product distribution and labeling plan. A plurality of beltplans may be created and stored using unique names. As indicated by 603A, a similar definition of traits, categories and thresholds may be established for the reference plan, however, as already noted, the reference plan is not used for distribution and labeling.

Following the establishment of the basic operational and system parameters by implementing modules 601-603, the operational plan is activated in a conventional manner using module 604. The user selects a predefined belt plan and activates it, thereby instructing the system to classify objects and physically sort them on the basis of the criteria of the plan. This is separate from an active reference plan, which in the present embodiment is limited to data collection and reporting. However, as would be understood by one skilled in the art, these functions can be integrated into a single module.

In module 605, the reference plan is separately activated. In executing this module, the user selects a predefined belt plan and activates it, instructing the system to measure each plan product and collect data based on the criteria of the plan. According to the present embodiment, this plan would not be the active operation plan. Moreover, more than one plan may be active to collect data in accordance with multiple sets of parameters.

The output of the operational plan module 604 and reference plan activation module 605 comprises data that is collected in using module 606 for evaluation and classification. Sensor data is collected and evaluated for each plant product object. The objects are classified on the basis of their sensor data and the criteria the user has defined and then queued for distribution. Data collected and evaluated by module 606 on the basis of the parameters provided by the operational plan module 604 differs from that collected and evaluated in module 606A under the parameters provided by the reference plan module 605. Inputs to the evaluation and classification module 606 includes a plurality of sensors 608a, 608b and 608c. The collected data may be sampled according to the last n pieces per lane, sorted and graphed.

Such data is useful in setting sorting criteria for the belt plans as feedback to module 603.

Data resulting from the operational plan activation by module 604 and from the evaluation and classification activity of module 606 are provided to a lot management module 609 in which grower information as well as other lot management features are assembled together with object count data that is collected and stored accordingly. Information from the reference plan is separately stored in connection with grower information as indicated by step 609a. Following evaluation and classification by module 606, a trademark, brand or other labeling system, which is provided only in the operational plan, including a labeling device or devices, is activated as the object passes the device, as desired using module 610. Finally, according to the operational plan, the distribution of product is undertaken using module 611 where the plant product is removed from the system at appropriate locations.

In addition, according to module 612, sets of takeouts may be grouped together and given an ID, which is utilized in a reporting module. Finally, a reporting system implemented using module 613, through which reports on both the operational plan and reference plan (using a portion of the module 613A) may be configured to automatically print or otherwise provide data and reports to remote locations, either automatically or on demand. Reports may be customized or conventional according to industry standards.

FIG. 13 illustrates the specific operations related to the definition of parameters for the enhanced system and the execution of an operational plan and reference plan for a plant product, specifically lemons. In step S71, the user defines the standards and parameters that are to be applied under the reference plan for an extended period such as an entire growing season. These parameters are stored in the data bank 402 (FIG. 10) and used for comparison against the measured data for lemons as they are processed through the packing plant system. In step S72, the lemons are input to the packing house system in accordance with the flow charts of FIGS. 1 or 2. In step S73, all of the lemons placed into the system are counted and measured. In step S74, the fruit may be classified and grouped, and in step S75, the fruit may be identified according to grower, lot and time of processing. The collected data is stored in the data bank in real-time in step S76.

In step S77, the stored data collected under the reference plan may be used for payment of the growers, or for other business or accounting purposes, that demand objective and consistent data based on long term criteria. Such data will result in a consistent and equitable basis for measuring production by participating growers and enable a uniform basis of compensation without subjectivity or variation.

Notably, the reference plan flow does not include steps relating to distribution or takeout. Such additional features are provided according to an operational plan. However, in a further reference plan embodiment, such additional controls may be applied, particularly if the reference plan serves as a substitution for an operational plan run in parallel.

FIG. 14 illustrates the substantially similar user interfaces that may be applied to the results of the operational plan and the reference plan. The assembly of data is presented in a similar manner, but represents the different standards that are applied under the reference plan.

FIG. 15 is an illustration of the difference in data between an operational plan and the reference plan. Historical data may be collected under the reference plan and provide trends by grower and block for multiple different grades versus the different lots processed over a season for a grower. As is clear from the illustration, under the operational plan, the data tends to be highly variable while, for the same processing, the data under the reference plan is smoother and reflects a more predictable characteristic.

FIG. 16 illustrates a comparison between the operational plan and reference plan for grade percentage versus lots. Severe spikes in the operational plan represent operator errors, which are endemic of the subjective judgment-based operation of a sampling system.

Under the enhanced system, settings don't change and are applied to all plants or processing facilities. The results are not subjective and not dependent upon which person will do the testing. Grading is automatic and avoids the inconsistency of human graders, under the enhanced system, key information is gathered and reflective of the content of storage and allows management to determine what to do with the inventory and how it compares to everything else that has been stored.

There are many further enhancements to the disclosed invention that may be implemented, beyond the detailed disclosure of exemplary embodiments herein. For example, it is possible to label each piece of fruit with a unique ID, such as a barcode or other tag, and to track each piece of fruit using such code or tag. Further, such code or tag may be useful for subsequent analysis of the storage process, by aiding in the identification of plant products that have subsequently decayed or been damaged or even lost. The present piece-by-piece identification and analysis of data for the delivered plant products will enable such result. Moreover, once a run has been completed, classification information can be saved and parametric data can be discarded.

These and other enhancements and their implementation would be understood by those skilled in the art.

1. A method of operating a plant product processing arrangement operative to process a plurality of plant product objects, said arrangement comprising an input, an output and processing, detecting, conveying and sorting equipment therebetween, comprising:
establishing at least one operational plan, said at least one operational plan defining short term operational parameters and controlling processing facility operations, including plant product detection, conveying, sorting and takeout at said output;
establishing a reference plan, said reference plan defining long term value-related parameters;
processing plant product objects according to said at least one operational plan from plant product input through plant product takeout;
detecting measurable parametric characteristics of each of said plant product objects during said processing step;
storing said detected parametric characteristics measured for each of said plant product objects;
comparing said detected parametric characteristics to said long term value related parameters and generating a comparison result for each plant product object; and
storing said comparison result.

2. The method of claim 1 further comprising processing said comparison results according to said long-term value related parameters.

3. The method of claim 2 wherein said processing step comprises accumulating said comparison results and analyzing said comparison results over a long term.

4. The method of claim 3 further comprising determining payment to plant product suppliers on the basis of said long term value-related parameters.

5. The method of claim 2 further comprising identifying said comparison results by at least quantity, supplier and time information.

6. The method of claim 2 further comprising classifying plant product objects according to said comparison result.

7. The method of claim 2 further comprising at least one of transmitting, using, archiving and accessing said comparison result.

8. The method of claim 7 further comprising generating reports on the basis of said comparison results.

9. The method of claim 7 wherein said accessing step comprises at least one of forwarding said stored data to a remote location.

10. The method of claim 9 further comprising forwarding said stored data by the Internet or an intranet.

11. A method of classifying plant products provided in bulk to a plant product processing facility having processing equipment for at least one of grading and sorting plant products and operative to execute predefined plant product processing, comprising:
establishing long-term value-related parameters;
measuring parametric characteristics of individual plant product objects;
comparing said long-term value-related parameters to said measured parametric characteristics
classifying each said plant product objects on the basis of said comparing step;
generating classification data from said classifying step; and
storing said classification data for each said plant product objects.

12. The method of claim 11 further comprising analyzing said stored classification data and generating classification reports.

13. The method of claim 12 further comprising generating classification reports on the basis of at least one of grade, size and supplier.

14. The method of claim 11 further comprising analyzing said stored classification data and providing extended statistical analysis about at least one of said plant product, said plant product processing, and processing equipment operation.

15. The method of claim 11 wherein at least said classifying step is performed under operator control.

16. The method of claim 11 wherein at least said classifying step is performed automatically.

17. A method of paying for plant products supplied for processing to a packing house, comprising:
establishing at least one set of long-term value-related parameters;
performing machine-based measurement of parametric characteristics of all individual plant product objects;
comparing said at least one set of long-term value-related parameters to said machine-based measured parametric characteristics
classifying each said plant product objects on the basis of said comparing step;
generating classification data from said classifying step and storing said classification data; and
utilizing said classification data for payment to growers of said plant products provided to said packing house.

18. The method of claim 17, wherein said long term value-related parameters are applied to plant products provided to the packing house for an entire growing season of said plant products.

19. The method of claim 17, wherein said long-term value related parameters are applied to plant products provided to the packing house by a plurality of growers.

20. The method of claim 17, wherein said payment is determined on the basis of a plurality of sets of long term value related parameters.

21. A plant product processing assembly comprising:
a plant product input for receiving in bulk a plurality of plant product objects;
a plant product output for taking out plant product objects in containers;
a plant product conveying system for conveying plant product objects past a plurality of processing and detecting locations, said processing locations comprising at least sorting equipment and said detecting locations comprising at least one of optical and electronic sensors for generating plant product data;
a computer processing system for controlling operation of said plant product processing assembly, said computer processing system comprising at least one CPU and at least one memory, said memory being operative to store said plant product data and a plurality of operational programs; and
at least one long term analytical program, comprising parameters for classifying all of the plant product objects, said program being operative under control of said computer processing system to store classification data in said memory.

22. The plant processing system as specified in claim 21 wherein said operational programs further comprise at least one short term operational program, comprising control data for controlling operation of said system, including at least controlling sorting and take out functions.

23. The plant processing system as specified in claim 21 further comprising a program for assisting an operator to statistically sample plant product objects

24. The plant processing system as specified in claim 21 further comprising a plurality of long term analytical programs, said programs being user defined and selectively actuated.

25. The plant processing system as specified in claim 21 further comprising programs for generating reports based on said stored data.

26. The plant processing system as specified in claim 21 further comprising at least one of Internet and/or intranet access ports and telecommunication interfaces for remote access to said stored data.

27. A method of operating an object processing arrangement, said arrangement comprising at least detecting, conveying and sorting means, comprising:
establishing at least a first plan defining short term operational parameters and controlling least one of said detecting, conveying and sorting means;
establishing at least a second plan, said second plan defining long term value-related parameters;
processing said objects according to said at least one first plan and detecting measurable parametric characteristics of each of said bjects during said processing step;
comparing said detected parametric characteristics to said long term value related parameters and generating a comparison result for each object.

28. The method of claim 27 further comprising processing said comparison results according to said long-term value related parameters.

29. The method of claim 28 wherein said processing step comprises accumulating said comparison results and analyzing said comparison results over a long term.

30. The method of claim 28 further comprising classifying said objects according to said comparison result.
